(19) United States
(12) Patent Application Publication
(10) Pub. No.: US 2025/0250139 A1
(43) Pub. Date: Aug. 7, 2025

(54) ASSEMBLY FOR TENSIONING WIRES FOR FORMING COMPONENTS OF ELECTRICAL WINDINGS

(71) Applicant: ATOP S.P.A., Barberino Tavarnelle (IT)

(72) Inventor: Rubino CORBINELLI, Poggibonsi, Frazione Staggia Senese (IT)

(21) Appl. No.: 18/855,661

(22) PCT Filed: Apr. 13, 2023
(86) PCT No.: PCT/EP2023/059683

§ 371 Date: Oct. 10, 2024

(30) Foreign Application Priority Data
Apr. 13, 2022 (IT) 102022000007304

(51) Int. Cl. B65H 59/36; B65H 51/14; H01F 41/094

(52) U.S. Cl. CPC B65H 59/36; B65H 51/14; H01F 41/094; B65H 2513/10; B65H 2513/20; B65H 2701/36

(57) ABSTRACT

An assembly for tensioning wires for forming components of electrical windings, which comprises at least one spool of wire arranged upstream of bending means, and at least one guide pulley that rotates on a carriage which translates along a respective guide by an actuator, the guide pulley being configured to redirect the wire originating from the spool; and a control and management unit designed to monitor dragging of the wire toward the bending means, so as to detect the dynamic behavior with which the wire moves. The control and management unit commands the actuator, in order to move the carriage along the guide with a rule of motion defined in feedback as a function of the dynamic behavior of the wire that has been detected by the control and management unit, so as to maintain the wire under tension.

The present invention relates to an assembly for tensioning wires for forming components of electrical windings.

Electric motors, dynamos, alternators and transformers comprise a core of ferromagnetic material on which windings are arranged which are made with electrical wires arranged according to a specific geometry. The circulation of a current in at least one of the windings determines, by electromagnetic induction, the circulation of an induced current in at least one other winding. Furthermore, forces between the windings and the respective ferromagnetic cores act on each other and are capable, for example, of turning the rotor with respect to the stator in an electric motor.

Inductive windings are made with elements made of electrically conducting material (generally copper) which are covered with a layer of dielectric material (not electrically conducting), for their insulation. For specific applications, providing the windings is done using pieces of electrically conducting material coupled to each other at at least one end, which are inserted into the specific recesses present in the ferromagnetic cores of the machine under construction. These pieces are called “hairpins” in the technical jargon.

Elements of copper (or other electrically conducting material) with which hairpins are made are supplied in spools and are cut and shaped on specific machines. During processing, the copper (or other electrically conducting material) wire must be unreeled from the spool and supplied to the stations for cutting and bending: its advancement along the system will occur according to predefined rules of motion, which may entail pauses and accelerations. For this reason the unreeling of the wire from the spool will not be performed continuously at a constant speed and this can determine problems of an inertial nature (it is difficult to confer to the spool—which is very heavy—a dynamic movement that follows the rule of motion steadily). The use is known of elastic guide means on which the wire is caused to pass, which must be interposed between the spool and the cutting and bending stations, so as to contain this problem, but this does not eliminate the problem.

The aim of the present invention is to solve the above-mentioned drawbacks, by providing an assembly for tensioning wires for forming components of electrical windings that makes it possible to make the wire obey the most suitable rule of motion, while unreeling it from the spool at a substantially constant speed.

Within this aim, an object of the invention is to provide an assembly for tensioning wires for forming components of electrical windings that makes it possible to keep the wire subjected to a traction that is such as to ensure the best positioning of the portion thereof that is destined for the cutting and bending station.

Another object of the invention is to provide an assembly for tensioning wires for forming components of electrical windings that can act as a dynamic buffer for the wire.

Another object of the invention is to provide an assembly for tensioning wires for forming components of electrical windings that offers reduced space occupation.

Another object of the present invention is to provide an assembly for tensioning wires for forming components of electrical windings which is low-cost, easily and practically implemented and safe in use.

This aim and these objects are achieved by an assembly for tensioning wires for forming components of electrical windings, particularly for machines that have at least one spool of wire arranged upstream of means which are configured for the bending and sizing of portions of wire, characterized in that at least one guide pulley is interposed between said spool and said means and is pivoted on a carriage which can translate along a respective guide by virtue of the action of an actuator, said assembly comprising a control and management unit which is designed at least to command said bending and sizing means and said actuator, the rule of motion of said carriage along said guide being defined in feedback by said unit as a function of the rule of motion of said wire within said bending and sizing means.

Such aim and such objects are also achieved by way of a machine for forming components of electrical windings, of the type comprising at least one spool of wire arranged upstream of means configured for the bending and sizing of portions of wire, characterized in that it comprises a wire tensioning assembly which is provided with a guide pulley which is pivoted on a carriage which can translate along a respective guide by virtue of the action of an actuator, said wire tensioning assembly being interposed between said spool and said means, said assembly comprising a control and management unit which is designed at least to command said bending and sizing means and said actuator, the rule of motion of said carriage along said guide being defined in feedback by said unit as a function of the rule of motion of said wire within said bending and sizing means.

Further characteristics and advantages of the invention will become more apparent from the detailed description that follows of a preferred, but not exclusive, embodiment of the assembly for tensioning wires for forming components of electrical windings, which is illustrated by way of non-limiting example in the accompanying drawings wherein:

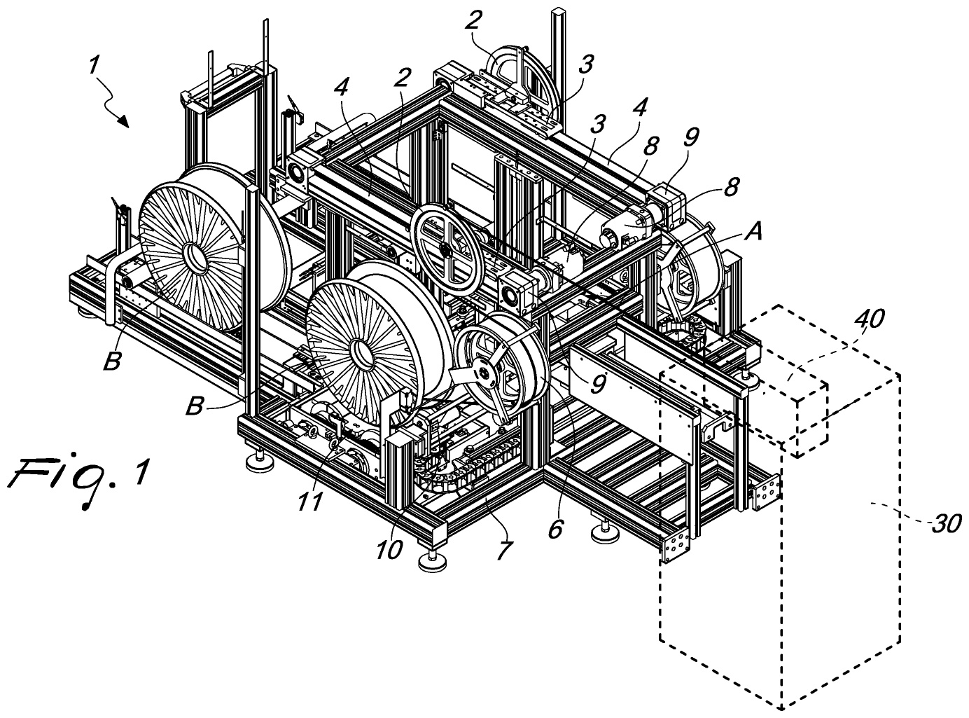

FIG. 1 is a schematic perspective view, from the front and side, of a possible embodiment of an assembly for tensioning wires for forming components of electrical windings according to the invention;

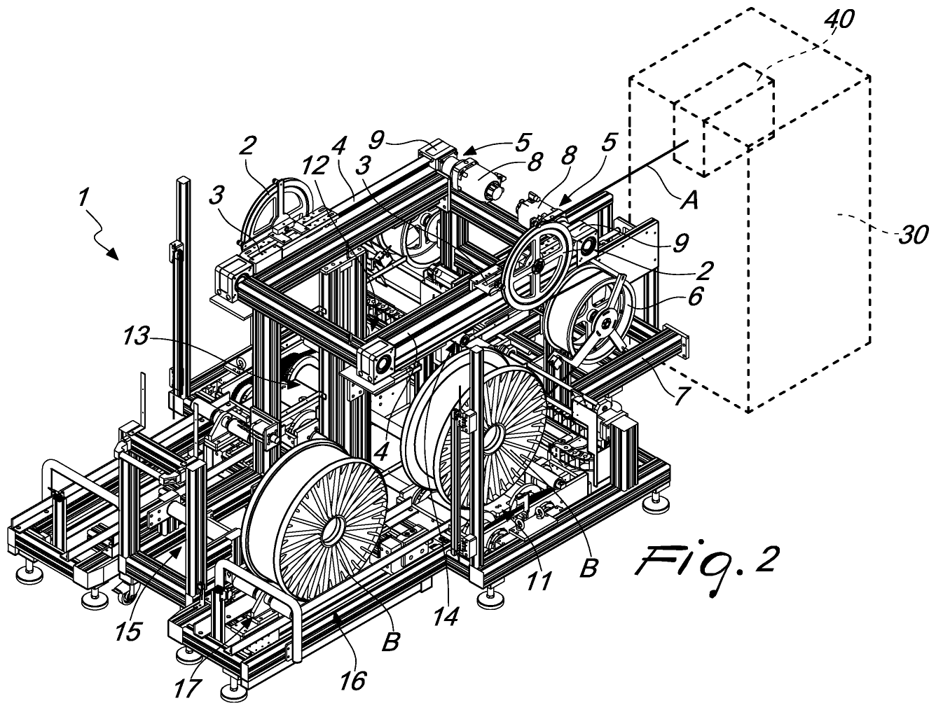

FIG. 2 is a schematic perspective view, from the rear and side, of the assembly of FIG. 1;

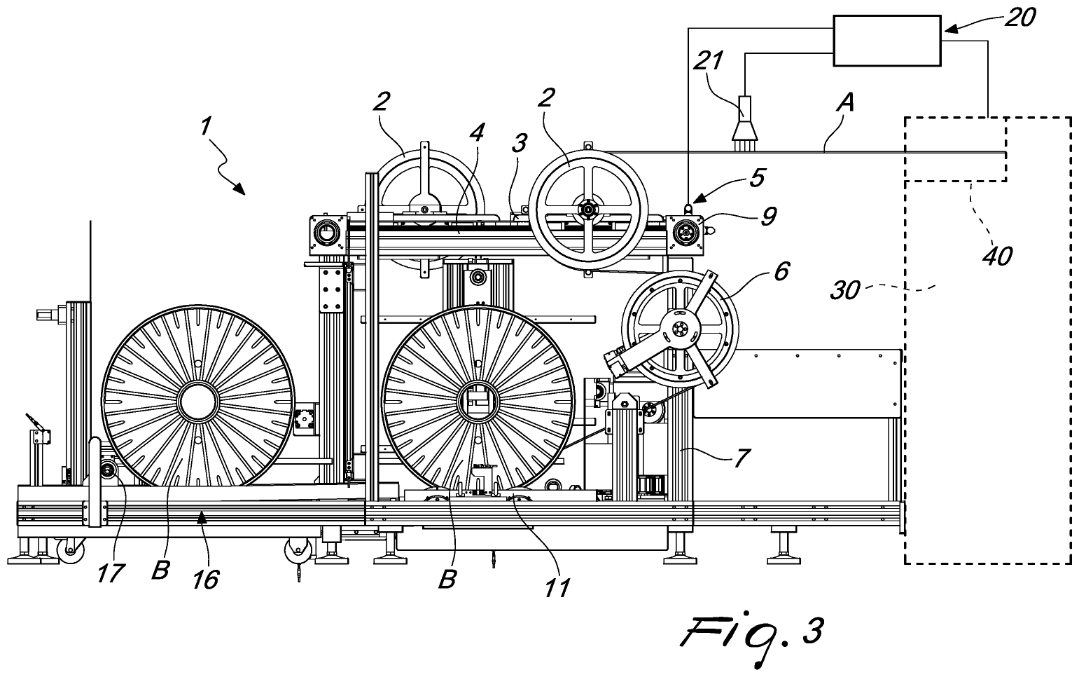

FIG. 3 is a schematic side view of the assembly of FIG. 1 with a movable pulley in a first limit configuration;

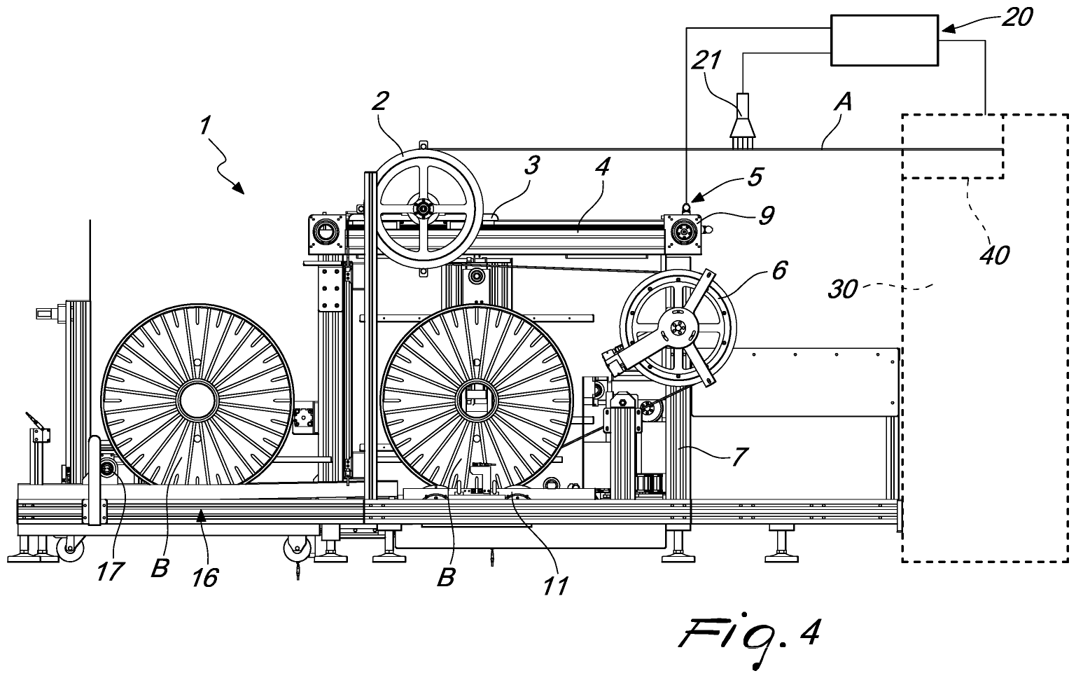

FIG. 4 is a schematic side view of the assembly of FIG. 1 with a movable pulley in a second limit configuration;

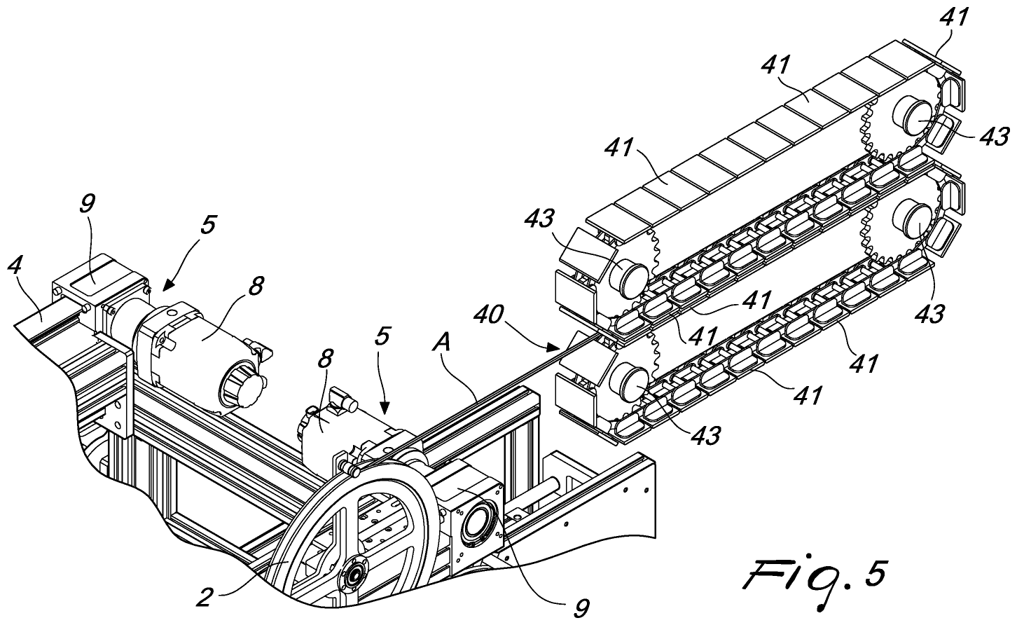

FIG. 5 is a schematic perspective view of motorized dragging means configured to drag the wire toward the bending means of an assembly according to the invention.

With reference to the figures, the reference numeral 1 generally designates an assembly for tensioning wires A for forming components of electrical windings.

The assembly 1 according to the invention is intended to be preferably installed in machines that have at least one spool B of wire A arranged upstream of bending means 30, which are configured for the controlled bending of portions of wire obtained from said wire A, shown in the accompanying figures exclusively by way of a generic square. The bending means 30 can advantageously also perform cutting operations for the purpose of imposing the desired length to each one of the portions of wire A: the bending and cutting operations performed by the bending means 30 can profitably be controlled by means of respective computer-controlled sensors.

According to the invention, at least one guide pulley 2, which is mounted so that it can rotate on a carriage 3 which can translate along a respective guide 4 by virtue of the action of an actuator 5, can conveniently be interposed between each spool B and the bending means 30 of the wire A: such guide pulley 2 is profitably configured to redirect the wire A originating from the spool B.

Advantageously the assembly 1 further comprises a control and management unit 20 which is designed at least for monitoring the dragging of the wire A toward the bending means 30, so as to detect the dynamic behavior with which the wire A moves, and for commanding the actuator 5: the rule of motion of the carriage 3 along the guide 4 is defined in feedback by the unit 20, as a function of the dynamic behavior of the wire A that has been detected by the control unit 20.

In an embodiment, the assembly 1 comprises motorized dragging means 40 which are configured to drag the wire A toward the bending means 30.

In some embodiments of the present invention the motorized dragging means 40 comprise a pair of belts 41 facing each other and spaced apart in order to accommodate the wire A interposed between the two belts 41, adopting a shape structure such that the belts 41 are configured to drag the wire A by virtue of the friction between the wire A and the belts 41.

With reference to an embodiment of the present invention, such motorized means 40 can conveniently be actuated by at least one first electric motor 42, 43 which is commanded by the control and management unit 20.

In any of the embodiments shown, the wire A always remains in a condition of ideal tensioning even though the wire is dispensed continuously and at constant speed from the spool B and acquired with a dynamic advancement behavior according to an irregular rule of motion (which entails sudden pauses and accelerations) by the bending and sizing means. The guide pulley 2 compensates for the incongruities between the movement of the wire A originating from the spool B and the movement of the wire A toward the bending means 30, by virtue of the movements of the carriage 3 along the guide 4 which will be commanded by the actuator 5 according to a feedback control logic that makes it possible to “reconcile” the two different rules of motion of the wire A (upstream and downstream of the pulley 2).

It is convenient to note that the assembly 1 according to the invention can conveniently comprise an idle pulley 6 the rotation axis of which is rigidly coupled to a frame 7.

The idle pulley 6 is arranged between the spool B and the guide pulley 2, so as to profitably allow the change of direction of the wire A originating from the spool B: by virtue of the presence of the idle pulley 6 it is furthermore possible to subject the wire A to a transverse deformation contrary to the deformation assumed within the spool A. In this manner a first rectification of the wire A is carried out, which facilitates all the subsequent operations. The diameter of the idle pulley 6 will be selected to best achieve this object.

With particular reference to an embodiment of undoubted practical and applicative interest, the actuator 5 can advantageously comprise a second electric motor 8 of the controlled type, coupled to a motion transmission element 9 which will be integral with the carriage 3. The second electric motor 8 can also be profitably associated with a respective position transducer (such as for example an encoder) in order to allow the constant monitoring of its movements and, if necessary, use the signals acquired by the transducer to execute operations to control the position (or, more generally, the rule of motion) of said second motor 8 (by way of a control which can be executed, for example, by the unit 20).

The motion transmission element 9 integral with the carriage will be of the type chosen from a belt, a worm screw transmission, a rack and pinion system, and the like. For the specific application, toothed couplings (or in any case mutually meshing couplings) will be preferred because these will make it possible to guard against any sliding with respect to the pinion associated with the shaft of the motor 8, thus ensuring maximum precision and promptness of the movements of the carriage 3 along the guide 4 (and therefore of the pulley 2).

It should be noted that in an embodiment the assembly 1 can profitably comprise at least one sensor 21 of type chosen from position sensors, speed sensors and acceleration sensors, which is deployed and configured to detect the position, speed and acceleration of the dragged wire A: such optional at least one sensor 21 will be connected to the control and management unit 20, so that it can detect the dynamic behavior with which the wire A moves and optionally conveniently adjust, as a consequence (according to a logic of substantial feedback), the actuator 5 and, therefore, the translations of the pulley 2. In more detail, the control and management unit 20 can profitably comprise modules that are configured to adjust the electric power supply parameters of the actuator 5, by adjusting and defining the rule of motion of the carriage 3 which rotatably supports the guide pulley 2 as a function of the data supplied by the at least one sensor 21.

The present invention also extends its protection to include a machine for forming components of electrical windings, which comprises means 30 of controlled bending and a tensioning assembly 1 according to an embodiment presented previously; such assembly 1 is arranged upstream of the means 30 of controlled bending of portions of wire A.

With particular reference to an embodiment of undoubted practical and applicative interest, the bending means 30 are configured to provide elements of electrical windings of the type of hairpins, i-pins, undulating elements or the like. According to the invention, such machine for forming can usefully comprise the assembly 1 for tensioning the wire A, provided with the guide pulley 2 pivoted on the carriage 3 which can translate along the guide 4 by virtue of the action of an actuator 5, of the type described previously.

As explained previously, the guide pulley 2 present in the machine according to the invention must be advantageously interposed between the spool B and the bending means 30 for the wire A.

The machine according to the invention will be provided with at least one control and management unit (the same unit 20, or an additional general processor, by which the unit 20 will also be controlled), which, in addition to performing the normal functions to command the various components of the machine it controls, will also be designed to detect the operating mode of the bending means (in particular acquiring the rule of motion of the wire A within those means) and to command the actuator 5.

In particular the rule of motion of the carriage 3 along the guide 4 (imposed by the actuator 5) will be defined in feedback by the unit, as a function of the rule of motion of the wire A within the bending means.

It should further be noted that the machine according to the invention can also positively comprise, downstream of the spool B and upstream of the assembly 1, a cutting device 10 for cutting the wire A originating from the spool B.

Such cutting device 10 will enter operation when the wire A in the spool B runs out, so as to facilitate operations to replace the exhausted spool A with one loaded with a predefined quantity of wire A.

With particular reference to the step of replacing an exhausted spool, it should be noted that the machine 1 can advantageously comprise a lower support 11 for the spool B. Such support 11 can be conveniently movable between an active arrangement, in which the spool B, rotating in place, dispenses the wire A, and a second arrangement for unloading, in which the spool B is translated along its axis into a region 12 for temporary accommodation aligned with an opening 13 of the machine.

At such region 12 for temporary accommodation there can advantageously be a pusher 14 which, by abutting against the edges of the exhausted spool B, will transfer it from the region 12 to an external supporting frame 15 by passing through the opening 13.

In this manner the exhausted spool B can be easily loaded onto the external supporting frame 15, which can be provided with wheels for its removal and the transfer of the exhausted spool B to a specific collection area.

The lower support 11, therefore, can be returned into its operating configuration (in which it is aligned, with particular reference to the accompanying figures, with the fixed pulley 6). A new spool B loaded with the predefined quantity of wire A can be placed on the support 11, at this point, by way of a loader 16 which can accommodate such spool B and which comprises a respective pusher 17 which is configured to transfer the spool B onto the support 11.

The subsequent operations to run the wire A along the pulleys 2 and 6 up to the bending means 30 for bending the wire A can subsequently be executed manually by an operator (although the possibility is not ruled out of adopting an automatic mechanism for these operations as well).

The present invention also extends its protection to include a method for tensioning wires A.

The method according to the invention comprises a first step during which it is necessary to unreel a wire A from at least one spool B which is configured to be arranged upstream of bending means 30 for the controlled bending of portions of wire obtained from the wire A.

In a second step it will be necessary to redirect the wire A while it is being unreeled from the spool B via a guide pulley 2 which is mounted so that it can rotate on a carriage 3 which can translate along a respective guide 4 by virtue of the action of an actuator 5.

Subsequently, actuating a third step entails dragging the wire A, redirected by the guide pulley 2, toward the bending means 30 while the wire is being unreeled from the spool B.

The method according to the invention is particularly original and innovative in that the step of dragging the wire A is at least monitored by a control and management unit 20, so as to detect the dynamic behavior with which the wire A moves. Furthermore, in the method according to the invention the control and management unit 20 is further designed to command the actuator 5, in order to move the carriage 3 along the guide 4 with a rule of motion defined in feedback as a function of the dynamic behavior of the wire A that will have been detected by the control and management unit 20, so as to maintain the wire A under tension.

In particular, furthermore the step of dragging can be conveniently performed by motorized dragging means 40 which are configured to drag the wire A toward the bending means 30.

More precisely, the step of dragging the wire A can advantageously follow a rule of motion comprising accelerations and decelerations which is preset on the control and management unit 20: such rule will be configured and dimensioned in order to allow the correct forming of portions of wire A according to a desired shape.

In particular, the step of dragging the wire A can be efficiently controlled by at least one sensor 21 of a type chosen from position sensors, speed sensors and acceleration sensors for the respective detection of the position, speed and acceleration of the wire A: such at least one sensor 21 will usefully be connected to the control and management unit 20.

Finally it should be noted that the spool B will positively perform the step containing the controlled unreeling of the wire A at a constant speed.

Advantageously the present invention solves the above-mentioned problems, by providing an assembly 1 for tensioning wires A for forming components of electrical windings that makes it possible to make the wire A obey the most suitable rule of motion, while unreeling it from the spool B at a substantially constant speed. By virtue of the assembly 1, the wire A always maintains the correct tensioning which makes it possible for the bending means 30 to catch it optimally (thus guarding against jams, irregularities in operation and other problems).

Conveniently the assembly 1 according to the invention therefore makes it possible to maintain the wire A under a traction that is such as to ensure the best positioning of the portion thereof that is destined for the subsequent cutting and bending station by virtue of the controlled movement of the pulley 2 along the guide 4.

Profitably the assembly 1 according to the invention can therefore act as a dynamic buffer for the wire A (making it possible to “reconcile” the continuous dispensing of wire A by the spool B with the intermittent and irregular use of the wire A by the bending means 30 that will provide the hairpin).

Positively the assembly 1 according to the invention offers contained encumbrances.

Positively the assembly 1 according to the invention is easily and practically implemented and low-cost. Such characteristics make the assembly 1 according to the invention, and also the machine that incorporates these characteristics, innovations that are safe in use.

The invention thus conceived is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102022000007304 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-15. (canceled)

16. An assembly for tensioning wires for forming components of electrical windings, which comprises:
at least one spool of wire which is configured to be arranged upstream of bending means, which are configured for a controlled bending of portions of wire obtained from said wire,
at least one guide pulley which is mounted to rotate on a carriage which translates along a respective guide by virtue of an actuator, said guide pulley being configured to redirect the wire originating from the spool,
wherein said assembly further comprises a control and management unit which is designed at least for monitoring a dragging of the wire toward said bending means, so as to detect a dynamic behavior with which the wire moves, and wherein said control and management unit is further designed to command the actuator, in order to move said carriage along said guide with a rule of motion defined in feedback as a function of the dynamic behavior of said wire that has been detected by the control and management unit, so as to maintain the wire under tension.

17. The assembly according to claim 16, further comprising motorized dragging means which are configured to drag the wire toward said bending means.

18. The assembly according to claim 17, wherein the motorized dragging means comprise a pair of belts facing each other and spaced apart in order to accommodate the wire interposed between the pair belts, said belts being configured to drag the wire by virtue of a friction between the wire and the belts.

19. The assembly according to claim 17, wherein said motorized dragging means are actuated by at least one first electric motor which is commanded by the control and management unit.

20. The assembly according to claim 16, further comprising an idle pulley an axis of rotation of which is rigidly coupled to a frame, said idle pulley being arranged between said spool and said guide pulley and configured to change a direction of the wire that arrives from said spool.

21. The assembly according to claim 19, wherein said actuator comprises a second electric motor which is coupled to a motion transmission element which is integral with said carriage.

22. The assembly according to the claim 21, wherein said motion transmission element which is integral with said carriage is of a type chosen from a belt, a toothed belt, a chain, a worm screw transmission, a rack and pinion system, and the like.

23. The assembly according to claim 16, further comprising at least one sensor of type chosen from position sensors, speed sensors and/or acceleration sensors, which is deployed and configured to detect the position, speed and/or acceleration of said dragged wire, said at least one sensor being connected to said control and management unit so as to detect said dynamic behavior with which the wire moves.

24. The assembly according to claim 16, wherein said control and management unit comprises modules configured to adjust electric power supply parameters of said actuator, by adjusting and defining the rule of motion of said carriage which supports said guide pulley so that it can rotate, said modules being configured to perform said adjustment as a function of data supplied by said at least one sensor.

25. A machine for forming components of electrical windings, which comprises:
bending means for bending portions of wire,
an assembly for tensioning wires according to claim 16, arranged upstream of the controlled bending means,
wherein the controlled bending means are configured to carry out elements of electrical windings of the type of hairpins, i-pins, undulating elements or the like.

26. A method for tensioning wires for forming components of electrical windings, which comprises:
unreeling a wire from at least one spool which is configured to be arranged upstream of bending means for the controlled bending of portions of wire obtained from said wire,
redirecting the wire while it is being unreeled from the spool via a guide pulley which is mounted so that it can rotate on a carriage which can translate along a respective guide by virtue of the action of an actuator,
dragging the wire, redirected by the guide pulley, toward the bending means while the wire is being unreeled from the spool,
wherein the step of dragging the wire is at least monitored by a control and management unit, so as to detect a dynamic behavior with which the wire moves, and wherein said control and management unit commands the actuator, in order to move said carriage along said guide with a rule of motion defined in feedback as a function of the dynamic behavior of said wire that has been detected by the control and management unit, so as to maintain the wire under tension.

27. The method according to claim 26, wherein the step of dragging is performed by motorized dragging means which are configured to drag the wire toward said bending means.

28. The method according to claim 27, wherein the step of dragging the wire follows a rule of motion comprising accelerations and decelerations which is preset on the control and management unit, said rule of motion being configured and dimensioned in order to allow a correct forming of portions of wire according to a desired shape.

29. The method according to claim 27, wherein the step of dragging the wire is controlled by at least one sensor of a type chosen from position sensors, speed sensors and/or acceleration sensors for the respective detection of the position, speed and/or acceleration of said wire, said at least one sensor being connected to said control and management unit.

30. The method according to claim 26, wherein said spool performs the step of unreeling the wire at a constant speed.
